(19) United States
(12) Patent Application Publication
(10) Pub. No.: US 2024/0405930 A1
(43) Pub. Date: Dec. 5, 2024

(54) METHOD AND APPARATUS FOR SENDING HYBRID AUTOMATIC REPEAT REQUEST (HARQ), AND METHOD AND APPARATUS FOR RECEIVING HARQ

(71) Applicant: Beijing Xiaomi Mobile Software Co., Ltd., Beijing (CN)

(72) Inventor: Kaiyue YAN, Beijing (CN)

(73) Assignee: Beijing Xiaomi Mobile Software Co., Ltd., Beijing (CN)

(21) Appl. No.: 18/697,187

(22) PCT Filed: Sep. 30, 2021
(86) PCT No.: PCT/CN2021/122385

§ 371 Date: Mar. 29, 2024

(51) Int. Cl. H04L 1/1867; H04L 1/06

(52) U.S. Cl. CPC H04L 1/1896; H04L 1/0687

(57) ABSTRACT

A method for sending a hybrid automatic repeat request (HARQ) includes receiving downlink data, generating HARQ feedback information based on the downlink data, and sending, based on a switching priority, the HARQ feedback information by using a first feedback mode or a second feedback mode. The first feedback mode is delayed feedback on a current carrier, the second feedback mode is feedback on a candidate carrier, and a terminal device supports switching between the first feedback mode and the second feedback mode.

### CROSS-REFERENCE TO RELATED APPLICATION

The present application is a U.S. National Stage of International Application No. PCT/CN2021/122385, filed on Sep. 30, 2021, the entire content of which is incorporated herein by reference for all purposes.

### BACKGROUND

With continuous development of mobile communication technologies, a topic of the ultra reliable and low latency communication (URLLC) is proposed in a background of the 5th generation mobile communication technology (5G). In the URLLC downlink semi-persistent scheduling (URLLC SPS) physical downlink shared channel (PDSCH) transmission, the terminal device needs to perform, for each piece of downlink data, corresponding hybrid automatic repeat request acknowledgement (HARQ-ACK) feedback to the base station.

### SUMMARY

The present application relates to the field of communication technologies, and in particular refers to a method and apparatus for sending a hybrid automatic repeat request (HARQ), and a method and apparatus for receiving an HARQ. An embodiment in a first aspect of the present application proposes a method for sending an HARQ. The method is performed by a terminal device, and the method includes receiving downlink data, generating HARQ feedback information based on the downlink data, and sending, based on a switching priority, the HARQ feedback information by using a first feedback mode or a second feedback mode, where the first feedback mode is delayed feedback on a current carrier, the second feedback mode is feedback on a switched candidate carrier, and the terminal device supports switching between the first feedback mode and the second feedback mode.

An embodiment in a second aspect of the present application proposes a method for receiving an HARQ. The method is performed by a network device, and includes sending downlink data to a terminal device, and receiving HARQ feedback information sent by the terminal device, where the HARQ feedback information is generated by the terminal device based on the downlink data, the HARQ feedback information is sent, by the terminal device based on a switching priority, by using a first feedback mode or a second feedback mode, the first feedback mode is delayed feedback on a current carrier, the second feedback mode is feedback on a switched candidate carrier, and switching between the first feedback mode and the second feedback mode is supported by the terminal device.

An embodiment in a third aspect of the present application proposes an apparatus for sending an HARQ. The apparatus includes a transceiving unit that is configured to receive downlink data, and a processing unit that is configured to generate HARQ feedback information based on the downlink data and send, based on a switching priority, the HARQ feedback information by using a first feedback mode or a second feedback mode, where the first feedback mode is delayed feedback on a current carrier, the second feedback mode is feedback on a switched candidate carrier, and the terminal device supports switching between the first feedback mode and the second feedback mode.

An embodiment in a fourth aspect of the present application proposes an apparatus for receiving an HARQ. The apparatus includes a transceiving unit that is configured to send downlink data to a terminal device, and receive HARQ feedback information sent by the terminal device, where the HARQ feedback information is generated by the terminal device based on the downlink data, the HARQ feedback information is sent, by the terminal device based on a switching priority, by using a first feedback mode or a second feedback mode, the first feedback mode is delayed feedback on a current carrier, the second feedback mode is feedback on a switched candidate carrier, and switching between the first feedback mode and the second feedback mode is supported by the terminal device.

An embodiment in a fifth aspect of the present application proposes a communication device. The device includes a processor and a memory. The memory stores a computer program, and the processor executes the computer program stored in the memory to cause the device to perform the method for sending an HARQ described in the embodiments of the first aspect.

An embodiment in a sixth aspect of the present application proposes a communication device. The device includes a processor and a memory. The memory stores a computer program, and the processor executes the computer program stored in the memory to cause the device to perform the method for receiving an HARQ described in the embodiments of the second aspect.

An embodiment in a seventh aspect of the present application proposes a communication device. The device includes a processor and an interface circuit. The interface circuit is configured to receive a code instruction and transmit the code instruction to the processor. The processor is configured to run the code instruction to cause the device to perform the method for sending an HARQ described in the embodiments of the first aspect.

An embodiment in an eighth aspect of the present application proposes a communication device. The device includes a processor and an interface circuit. The interface circuit is configured to receive a code instruction and transmit the code instruction to the processor. The processor is configured to run the code instruction to cause the device to perform the method for receiving an HARQ described in the embodiments of the second aspect.

An embodiment in a ninth aspect of the present application proposes a computer-readable storage medium that is used for storing an instruction. The instruction, when executed, causes the method for sending an HARQ described in the embodiments of the first aspect to be implemented.

An embodiment in a tenth aspect of the present application proposes a computer-readable storage medium that is used for storing an instruction. The instruction, when executed, causes the method for receiving an HARQ described in the embodiments of the second aspect to be implemented.

An embodiment in an eleventh aspect of the present application proposes a computer program. The computer program, when run on a computer, causes the computer to perform the method for sending an HARQ described in the embodiments of the first aspect.

An embodiment in a twelfth aspect of the present application proposes a computer program. The computer program, when run on a computer, causes the computer to perform the method for receiving an HARQ described in the embodiments of the second aspect.

Additional aspects and advantages of the present application will be partially provided in the following description, and a part of the additional aspects and advantages will become apparent from the following description, or will be understood through practice of the present application.

### BRIEF DESCRIPTION OF THE DRAWINGS

In order to more clearly illustrate the technical solutions in the embodiments of the present application or the background, accompanying drawings required to be used in the embodiments of the present application or the background will be described below.

FIG. 1 is a schematic diagram of an architecture of a communication system provided by an embodiment of the present application.

FIG. 2 is a schematic flowchart of a method for sending an HARQ provided by an embodiment of the present application.

FIG. 3 is a schematic flowchart of a method for sending an HARQ provided by an embodiment of the present application.

FIG. 4 is a schematic flowchart of a method for sending an HARQ provided by an embodiment of the present application.

FIG. 5 is a schematic flowchart of a method for sending an HARQ provided by an embodiment of the present application.

FIG. 6 is a schematic flowchart of a method for receiving an HARQ provided by an embodiment of the present application.

FIG. 7 is a schematic flowchart of a method for receiving an HARQ provided by an embodiment of the present application.

FIG. 8 is a schematic flowchart of a method for receiving an HARQ provided by an embodiment of the present application.

FIG. 9 is a schematic flowchart of a method for receiving an HARQ provided by an embodiment of the present application.

FIG. 10 is a schematic diagram of a structure of an apparatus for sending an HARQ provided by an embodiment of the present application.

FIG. 11 is a schematic diagram of a structure of an apparatus for receiving an HARQ provided by an embodiment of the present application.

FIG. 12 is a schematic diagram of a structure of another apparatus for sending or receiving an HARQ provided by an embodiment of the present application.

FIG. 13 is a schematic diagram of a structure of a chip provided by an embodiment of the present disclosure.

### DETAILED DESCRIPTION

Exemplary embodiments are explained in detail here, and examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the embodiments of the present application. On the contrary, they are only examples of devices and methods consistent with some aspects of the embodiments of the present application as detailed in the attached claims.

The terms used in the embodiments of the present application are used solely for the purpose of describing particular embodiments and are not intended to limit the embodiments of the present application. The singular forms of “a” and “the” used in the embodiments of the present application and the appended claims are also intended to include the majority form, unless the context clearly indicates other meanings. It should also be understood that the term “and/or” as used herein refers to and includes any or all possible combinations of one or more of the associated listed items.

It should be understood that although the terms first, second, third, etc. may be used in the embodiments of the present application to describe various types of information, such information should not be limited to these terms. These terms are only used to distinguish the same type of information from one another. For example, without departing from the scope of the embodiments of the present application, the first information may also be referred to as the second information, and similarly, the second information may also be referred to as the first information. Depending on the context, the phrases “in case” and “if” as used herein may be interpreted as “at the time of . . . ”, “when . . . ”, or “in response to determining”.

The embodiments of the present application are described in detail below, and examples of the embodiments are illustrated in the accompanying drawings, where the same or similar labels throughout indicate the same or similar elements. The embodiments described below by reference to the accompanying drawings are exemplary, and are intended to be used for explaining the present application and are not to be construed as a limitation of the present application.

Communication systems to which the embodiments of the present application are applicable are first described below in order to better understand the method for sending an HARQ disclosed in the embodiments of the present application.

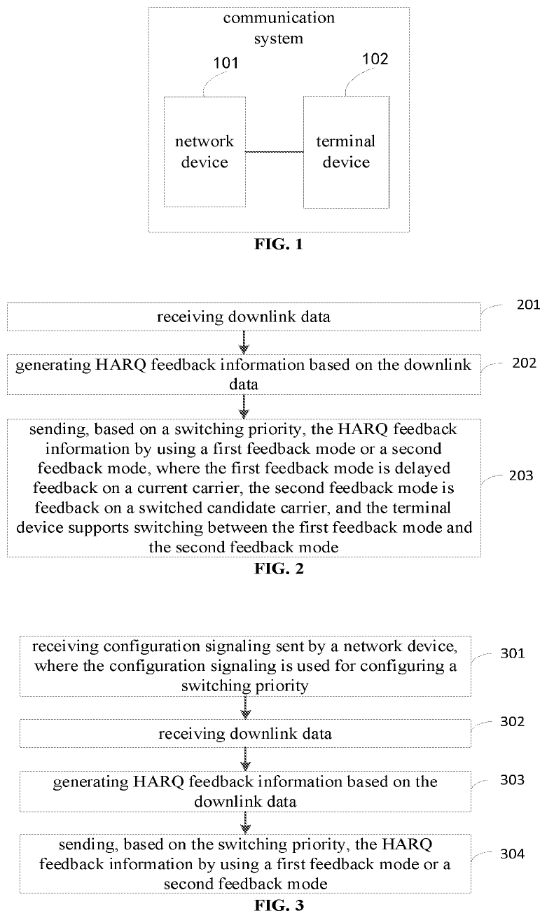

Referring to FIG. 1, FIG. 1 is a schematic diagram of an architecture of a communication system provided by an embodiment of the present application. The communication system may include, but is not limited to, a network device and a terminal device. The numbers and forms of the devices shown in FIG. 1 are for example only and do not constitute a limitation to the embodiments of the present application, and two or more network devices and two or more terminal devices may be included in actual applications. The communication system shown in FIG. 1 includes a network device 101 and a terminal device 102 as an example.

It should be illustrated that the technical solutions of the embodiments of the present application may be applied to various communication systems, for example, long-term evolution (LTE) systems, 5th generation mobile communication systems, 5G new radio systems, or other future new mobile communication systems.

The network device 101 in an embodiment of the present application is an entity at the network side for sending or receiving signals. For example, the network device 101 may be an evolved NodeB (eNB), a transmission reception point (TRP), a next generation NodeB (gNB) in NR systems, a base station in other future mobile communication systems, or an access node in wireless fidelity (WiFi) systems. The embodiments of the present application do not limit the specific technology and device form used by the network device. The network device provided by an embodiment of the present application may be composed of a central unit (CU) and a distributed unit (DU), where the CU may also be referred to as a control unit, the CU-DU structure may be used to separate the protocol layer of the network device such as a base station, with a part of functions of the protocol layer placed under centralized control in the CU, and the remaining functions or all functions of the protocol layer distributed in the DU, and the DU being centrally controlled by the CU.

The terminal device 102 in an embodiment of the present application is an entity at the user side for receiving or sending signals, such as a mobile phone. The terminal device may also be referred to as a terminal, a user equipment (UE), a mobile station (MS), a mobile terminal (MT), etc. The terminal device may be a device with communication capabilities such as a car, a smart car, a mobile phone, a wearable device, or a pad; or the terminal device may be a computer with wireless transceiving capabilities, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present application do not limit the specific technology and device form used by the terminal device.

The terminal device 102 may detect downlink data as received for error correction and send feedback information to the network device 101 based on a detecting result. If the data has been received correctly, the terminal device 102 sends a hybrid automatic repeat request acknowledgement (HARQ-ACK). After receiving the HARQ-ACK feedback from the terminal device 102, the network device 101 may continue to send a next set of data.

In related art, there is a need for frequent feedback of the HARQ-ACK, however, in time division duplex (TDD) systems, there are a large number of unavailable uplink symbols, and resources available for the feedback of the HARQ-ACK are limited, which can easily lead to a problem of a large number of SPS HARQ-ACK discards.

In the embodiment of the present application, by receiving the downlink data, generating the HARQ feedback information based on the downlink data, and sending, based on the switching priority, the HARQ feedback information by using the first feedback mode or the second feedback mode, where the first feedback mode is the delayed feedback on the current carrier, the second feedback mode is the feedback on the switched candidate carrier, and the terminal device supports switching between the first feedback mode and the second feedback mode, the terminal device is enabled to switch the feedback mode flexibly as required to send the HARQ feedback information, avoiding the situation where the HARQ feedback information is discarded, and ensuring the reliability of the sending of the HARQ feedback information and the feedback efficiency.

It can be understood that the communication system described in the embodiments of the present application is intended to provide a clearer explanation of the technical solutions of the embodiments of the present application, and does not constitute a limitation to the technical solutions provided by the embodiments of the present application. As those ordinary skilled in the art may know, with evolution of the system architecture and emergence of new service scenarios, the technical solutions provided by the embodiments of the present application are also applicable to similar technical problems.

The method and apparatus for sending an HARQ provided by the present application are described in detail below in conjunction with the accompanying drawings.

Referring to FIG. 2, FIG. 2 is a schematic flowchart of a method for sending an HARQ provided by an embodiment of the present application. It should be illustrated that the method for sending an HARQ in the embodiment of the present application is performed by a terminal device. As shown in FIG. 2, the method may include the following steps 201 to 203.

At step 201, downlink data is received.

At step 202, HARQ feedback information is generated based on the downlink data.

It can be understood that the terminal device, after receiving the downlink data, may detect the downlink data for error correction and generate the HARQ feedback information based on the detecting result. In some embodiments, the HARQ feedback information may be feedback information when the downlink data is correctly received or feedback information when the downlink data reception fails, and the present application does not make limitations to this.

At step 203, the HARQ feedback information is sent, based on a switching priority, by using a first feedback mode or a second feedback mode, where the first feedback mode is delayed feedback on a current carrier, the second feedback mode is feedback on a switched candidate carrier, and the terminal device supports switching between the first feedback mode and the second feedback mode.

In some embodiments, the current carrier refers to a carrier on which the terminal device receives PDSCH data and currently used by the terminal device to send the HARQ feedback information. The candidate carrier refers to a carrier, other than the current carrier, that the terminal device can use to send the HARQ feedback information.

In some embodiments, the first feedback mode is the delayed feedback on the current carrier, i.e., deferring the feedback of the HARQ feedback information to a next available feedback resource on the current carrier. The second feedback mode is the feedback on the switched candidate carrier. It should be illustrated that the candidate carrier that is switched to and is finally used to send the HARQ feedback information in the second feedback mode may be any one of a plurality of candidate carriers, for example, the number of candidate carriers may be 2 or 4, and the second feedback mode may be switching to any candidate carrier of the 2 or 4 candidate carriers and performing the feedback of the HARQ feedback information on the switched candidate carrier. In some embodiments, the feedback resource may refer to a physical uplink control channel (PUCCH) time frequency resource.

Additionally, the terminal device supports switching between the first feedback mode and the second feedback mode. In some embodiments, the switching refers to switching between the first feedback mode and the second feedback mode.

The switching priority may be understood as an execution order of the first feedback mode and the second feedback mode. In some embodiments, the switching priority may be agreed upon by a protocol, may be indicated by a network device, may be determined after deliberation between the terminal device and the network device, or may be determined by other means, and the present application does not make limitations to this.

In some exemplary embodiments, after generating the HARQ feedback information based on the downlink data, the terminal device may send, based on the switching priority, the HARQ feedback information by using the first feedback mode or the second feedback mode. For example, the switching priority may be that the terminal device preferentially performs the feedback of the HARQ feedback information on the switched candidate carrier when there is an available candidate carrier, and the terminal device performs the delayed feedback on the current carrier when there is no available candidate carrier; or the switching priority may be that the terminal device performs the delayed feedback on the current carrier when there is an available feedback resource on the current carrier, and the terminal device performs the feedback on the switched candidate carrier when there is no available feedback resource found on the current carrier. As a result, each piece of HARQ feedback information can be sent to the network device in a timely and reliable manner through flexibly switching of the feedback mode, thereby avoiding the situation where the HARQ feedback information is discarded, and ensuring the reliability of the sending of the HARQ feedback information and the feedback efficiency.

In summary, by receiving the downlink data, generating the HARQ feedback information based on the downlink data, and sending, based on the switching priority, the HARQ feedback information by using the first feedback mode or the second feedback mode, where the first feedback mode is the delayed feedback on the current carrier, the second feedback mode is the feedback on the switched candidate carrier, and the terminal device supports switching between the first feedback mode and the second feedback mode, the terminal device is enabled to switch the feedback mode flexibly as required to send the HARQ feedback information, avoiding the situation where the HARQ feedback information is discarded, and ensuring the reliability of the sending of the HARQ feedback information and the feedback efficiency.

Referring to FIG. 3, FIG. 3 is a schematic flowchart of a method for sending an HARQ provided by an embodiment of the present application. It should be illustrated that the method for sending an HARQ in the embodiment of the present application may be performed by a terminal device, and the method for sending an HARQ may be executed alone, may be executed in combination with any one of the embodiments of the present disclosure or possible implementations of the embodiments of the present disclosure, or may be executed in combination with any one of the technical solutions in the related art. As shown in FIG. 3, the method may include the following steps 301 to 304.

At step 301, configuration signaling sent by a network device is received, where the configuration signaling is used for configuring a switching priority.

In some embodiments, the switching priority may be understood as an execution order of a first feedback mode and a second feedback mode. Herein, the description of the first feedback mode and the second feedback mode may be referred to the description of the above embodiments and will not be repeated herein.

Additionally, the terminal device supports switching between the first feedback mode and the second feedback mode. In some embodiments, the switching refers to switching between the first feedback mode and the second feedback mode.

It can be understood that the network device may send the configuration signaling to the terminal device, and the configuration signaling is used for configuring the switching priority, such that the terminal device may determine the switching priority of the first feedback mode and the second feedback mode based on the configuration signaling as received.

In some exemplary embodiments, the configuration signaling may be radio resource control (RRC) signaling.

In some exemplary embodiments, the switching priority may be configured by means of semi-static configuration. For example, the network device may send the configuration signaling to the terminal device at a long period; or the switching priority may be configured by other means, and the present application does not make limitations to this.

At step 302, downlink data is received.

At step 303, HARQ feedback information is generated based on the downlink data.

It can be understood that the terminal device, after receiving the downlink data, may detect the downlink data for error correction and generate the HARQ feedback information based on the detecting result. In some embodiments, the HARQ feedback information may be feedback information when the downlink data is correctly received or feedback information when the downlink data reception fails, and the present application does not make limitations to this.

It should be illustrated that step 301 may be executed before step 302, may be executed at the same time as step 302, or may be executed after step 302, and the present application does not limit the timing of the execution of step 301. The embodiment of the present application is illustrated by taking the execution of step 301 before step 302 as an example.

At step 304, the HARQ feedback information is sent, based on the switching priority, by using the first feedback mode or the second feedback mode.

In some exemplary embodiments, after generating the HARQ feedback information based on the downlink data, the terminal device may send, based on the switching priority, the HARQ feedback information by using the first feedback mode or the second feedback mode.

In an embodiment of the present application, the switching priority may be: if a condition for the second feedback mode is satisfied, preferentially using the second feedback mode for feedback; if not, using the first feedback mode for feedback. In some embodiments, the condition for the second feedback mode refers to that the terminal device has a carrier, other than the current carrier, that can be used to send the HARQ feedback information.

Specifically, when sending the HARQ feedback information based on this switching priority, if the terminal device has a candidate carrier, other than the current carrier, that can be used to send the HARQ feedback information, the terminal device may preferentially switch to the candidate carrier and perform the feedback of the HARQ feedback information on the switched candidate carrier; if the terminal device does not have a candidate carrier, other than the current carrier, that can be used to send the HARQ feedback information, the terminal device may defer the feedback of the HARQ feedback information to a next available feedback resource on the current carrier.

In an embodiment of the present application, the switching priority may also be: if a condition for the first feedback mode is satisfied, preferentially using the first feedback mode for feedback; if no available feedback resource is found on the current carrier, switching to the candidate carrier by using the second feedback mode, where using the first feedback mode for feedback is further supported on the candidate carrier. In some embodiments, the feedback resource may refer to a PUCCH time frequency resource. The condition for the first feedback mode refers to that there is an available feedback resource on the current carrier. Using the first feedback mode for feedback being further supported on the candidate carrier refers to that delayed feedback of the HARQ feedback information may be performed on the candidate carrier.

Specifically, when sending the HARQ feedback information based on this switching priority, if there is an available feedback resource on the current carrier, the terminal device preferentially defers the feedback of the HARQ feedback information to a next available feedback resource, and if no available feedback resource is found on the current carrier, the terminal device switches to the candidate carrier and performs the feedback of the HARQ feedback information on the switched candidate carrier. Further, when switching to the candidate carrier for the feedback of the HARQ feedback information, if still no available feedback resource is found on the candidate carrier, the terminal device may defer the feedback of the HARQ feedback information to a next available feedback resource on the candidate carrier.

In an embodiment of the present application, the switching priority may also be: if a condition for the first feedback mode is satisfied, preferentially using the first feedback mode for feedback; if no available feedback resource is found on the current carrier, switching to the candidate carrier by using the second feedback mode, where using the first feedback mode for feedback is not further supported on the candidate carrier. In some embodiments, the feedback resource may refer to a PUCCH time frequency resource. The condition for the first feedback mode refers to that there is an available feedback resource on the current carrier. Using the first feedback mode for feedback being not further supported on the candidate carrier refers to that delayed feedback of the HARQ feedback information cannot be performed on the candidate carrier.

Specifically, when sending the HARQ feedback information based on this switching priority, if there is an available feedback resource on the current carrier, the terminal device preferentially defers the feedback of the HARQ feedback information to a next available feedback resource, and if no available feedback resource is found on the current carrier, the terminal device switches to the candidate carrier and performs the feedback of the HARQ feedback information on the switched candidate carrier. Further, when switching to the candidate carrier for the feedback of the HARQ feedback information, if still no available feedback resource is found on the candidate carrier, the terminal device may further switch to another candidate carrier for feedback as using the first feedback mode for feedback is not further supported on the candidate carrier. By sending the HARQ feedback information based on this switching priority, algorithm complexity is reduced, and resources are saved.

As a result, each piece of HARQ feedback information can be sent to the network device in a timely and reliable manner through flexibly switching of the feedback mode, thereby avoiding the situation where the HARQ feedback information is discarded, and ensuring the reliability of the sending of the HARQ feedback information and the feedback efficiency.

In summary, by receiving the configuration signaling sent by the network device, where the configuration signaling is used for configuring the switching priority, receiving the downlink data, generating the HARQ feedback information based on the downlink data, and sending, based on the switching priority, the HARQ feedback information by using the first feedback mode or the second feedback mode, the terminal device is enabled to switch the feedback mode flexibly as required to send the HARQ feedback information, avoiding the situation where the HARQ feedback information is discarded, and ensuring the reliability of the sending of the HARQ feedback information and the feedback efficiency.

Referring to FIG. 4, FIG. 4 is a schematic flowchart of a method for sending an HARQ provided by an embodiment of the present application. It should be illustrated that the method for sending an HARQ in the embodiment of the present application may be performed by a terminal device, and the method for sending an HARQ may be executed alone, may be executed in combination with any one of the embodiments of the present disclosure or possible implementations of the embodiments of the present disclosure, or may be executed in combination with any one of the technical solutions in the related art. As shown in FIG. 4, the method may include the following steps 401 to 404.

At step 401, downlink control information (DCI) sent by a network device is received, where the DCI is used for indicating a switching priority.

In some embodiments, the switching priority may be understood as an execution order of a first feedback mode and a second feedback mode. Herein, the description of the first feedback mode and the second feedback mode may be referred to the description of the above embodiments and will not be repeated herein.

Additionally, the terminal device supports switching between the first feedback mode and the second feedback mode. In some embodiments, the switching refers to switching between the first feedback mode and the second feedback mode.

It can be understood that the network device may send the DCI to the terminal device, and the DCI is used for indicating the switching priority, such that the terminal device may determine the switching priority of the first feedback mode and the second feedback mode based on the DCI as received.

At step 402, downlink data is received.

At step 403, HARQ feedback information is generated based on the downlink data.

It can be understood that the terminal device, after receiving the downlink data, may detect the downlink data for error correction and generate the HARQ feedback information based on the detecting result. In some embodiments, the HARQ feedback information may be feedback information when the downlink data is correctly received or feedback information when the downlink data reception fails, and the present application does not make limitations to this.

It should be illustrated that step 401 may be executed before step 402, may be executed at the same time as step 402, or may be executed after step 402, and the present application does not limit the timing of the execution of step 401. The embodiment of the present application is illustrated by taking the execution of step 401 before step 402 as an example.

At step 404, the HARQ feedback information is sent, based on the switching priority, by using the first feedback mode or the second feedback mode.

In some exemplary embodiments, after generating the HARQ feedback information based on the downlink data, the terminal device may send, based on the switching priority, the HARQ feedback information by using the first feedback mode or the second feedback mode.

In an embodiment of the present application, the switching priority may be: when the DCI includes a first identification, sending the HARQ feedback information by using the first feedback mode; when the DCI includes a second identification, sending the HARQ feedback information by using the second feedback mode. In some embodiments, the first identification and the second identification may be set as desired. For example, the first identification may be 1, and the second identification may be 0; or the first identification may be 0, and the second identification may be 1.

In some exemplary embodiments, a new field may be added to the DCI, such as a first field, and the first field may be used to indicate the switching priority. The HARQ feedback information is sent by using the first feedback mode when the first field in the DCI is the first identification, and the HARQ feedback information is sent by using the second feedback mode when the first field in the DCI is the second identification.

In some embodiments, the length of the newly added field may be 1 bit in order to save overhead. For example, the first field in the DCI may be set to 0 to indicate sending the HARQ feedback information by using the first feedback mode, and the first field in the DCI may be set to 1 to indicate sending the HARQ feedback information by using the second feedback mode; or, similarly, the first field in the DCI may be set to 1 to indicate sending the HARQ feedback information by using the first feedback mode, and the first field in the DCI may be set to 0 to indicate sending the HARQ feedback information by using the second feedback mode.

In some exemplary embodiments, an existing field in the DCI may be multiplexed to indicate the switching priority. For example, an uplink (UL) or supplementary uplink (SUL) indication field in the DCI may be multiplexed to indicate the switching priority, with the UL or SUL in the DCI being the first identification to indicate sending the HARQ feedback information by using the first feedback mode, and the UL or SUL in the DCI being the second identification to indicate sending the HARQ feedback information by using the second feedback mode. In some embodiments, the field length of the UL/SUL in the DCI is 1 bit.

In some exemplary embodiments, the UL or SUL indication field in the two formats DCI0_1/DCI0_2 may be specifically multiplexed to indicate the switching priority, with the UL or SUL in the DCI0_1/DCI0_2 being the first identification to indicate sending the HARQ feedback information by using the first feedback mode, and the UL or SUL in the DCI0_1/DCI0_2 being the second identification to indicate sending the HARQ feedback information by using the second feedback mode.

For example, the UL or SUL in the DCI0_1/DCI0_2 may be set to 0 to indicate sending the HARQ feedback information by using the first feedback mode, and the UL or SUL in the DCI0_1/DCI0_2 may be set to 1 to indicate sending the HARQ feedback information by using the second feedback mode; or, similarly, the UL or SUL in the DCI0_1/DCI0_2 may be set to 1 to indicate sending the HARQ feedback information by using the first feedback mode, and the UL or SUL in the DCI0_1/DCI0_2 may be set to 0 to indicate sending the HARQ feedback information by using the second feedback mode.

Taking the first identification as 0 and the second identification as 1 as an example, when sending the HARQ feedback information based on the above switching priority, if the UL or SUL in the DCI received by the terminal device is 1, the terminal device may switch to the candidate carrier and perform the feedback of the HARQ feedback information on the switched candidate carrier; and if the UL or SUL in the DCI received by the terminal device is 0, the terminal device may defer the feedback of the HARQ feedback information to a next available feedback resource on the current carrier.

As a result, each piece of HARQ feedback information can be sent to the network device in a timely and reliable manner through flexibly switching of the feedback mode, thereby avoiding the situation where the HARQ feedback information is discarded, and ensuring the reliability of the sending of the HARQ feedback information and the feedback efficiency.

In summary, by receiving the DCI sent by the network device, where the DCI is used for indicating the switching priority, receiving the downlink data, generating the HARQ feedback information based on the downlink data, and sending, based on the switching priority, the HARQ feedback information by using the first feedback mode or the second feedback mode, the terminal device is enabled to switch the feedback mode flexibly as required to send the HARQ feedback information, avoiding the situation where the HARQ feedback information is discarded, and ensuring the reliability of the sending of the HARQ feedback information and the feedback efficiency.

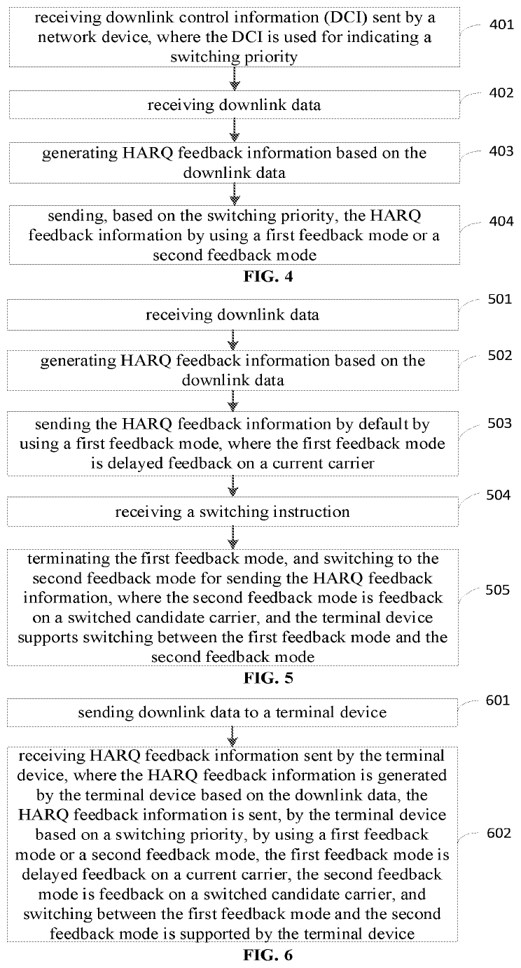

Referring to FIG. 5, FIG. 5 is a schematic flowchart of a method for sending an HARQ provided by an embodiment of the present application. It should be illustrated that the method for sending an HARQ in the embodiment of the present application may be performed by a terminal device, and the method for sending an HARQ may be executed alone, may be executed in combination with any one of the embodiments of the present disclosure or possible implementations of the embodiments of the present disclosure, or may be executed in combination with any one of the technical solutions in the related art. As shown in FIG. 5, the method may include the following steps 501 to 505.

At step 501, downlink data is received.

At step 502, HARQ feedback information is generated based on the downlink data.

It can be understood that the terminal device, after receiving the downlink data, may detect the downlink data for error correction and generate the HARQ feedback information based on the detecting result. In some embodiments, the HARQ feedback information may be feedback information when the downlink data is correctly received or feedback information when the downlink data reception fails, and the present application does not make limitations to this.

At step 503, the HARQ feedback information is sent by default by using a first feedback mode, where the first feedback mode is delayed feedback on a current carrier.

At step 504, a switching instruction is received.

At step 505, the first feedback mode is terminated, and the second feedback mode is switched to for sending the HARQ feedback information, where the second feedback mode is feedback on a switched candidate carrier, and the terminal device supports switching between the first feedback mode and the second feedback mode.

Herein, the description of the first feedback mode and the second feedback mode may be referred to the description of the above embodiments and will not be repeated herein.

Additionally, the terminal device supports switching between the first feedback mode and the second feedback mode. In some embodiments, the switching refers to switching between the first feedback mode and the second feedback mode.

In some embodiments, the switching instruction is used for indicating the terminal device to switch the feedback mode of the HARQ feedback information.

In an embodiment of the present application, the switching instruction may be DCI including a first identification or a second identification. In some embodiments, when the DCI received by the terminal device includes the first identification, the terminal device is indicated to switch from the second feedback mode to the first feedback mode for sending the HARQ feedback information; and when the DCI received by the terminal device includes the second identification, the terminal device is indicated to switch from the first feedback mode to the second feedback mode for sending the HARQ feedback information. In some embodiments, the first identification and the second identification may be set as desired. For example, the first identification may be 1, and the second identification may be 0; or the first identification may be 0, and the second identification may be 1.

In some exemplary embodiments, a new field may be added to the DCI, such as a first field, and the first field is used to indicate the switching of the feedback mode. The terminal device is indicated to switch from the second feedback mode to the first feedback mode for sending the HARQ feedback information when the first field in the DCI is the first identification, and terminal device is indicated to switch from the first feedback mode to the second feedback mode for sending the HARQ feedback information when the first field in the DCI is the second identification.

In some embodiments, the length of the newly added field may be 1 bit in order to save overhead. For example, the first field in the DCI may be set to 0 to indicate the terminal device to switch from the second feedback mode to the first feedback mode for sending the HARQ feedback information, and the first field in the DCI may be set to 1 to indicate the terminal device to switch from the first feedback mode to the second feedback mode for sending the HARQ feedback information; or, similarly, the first field in the DCI may be set to 1 to indicate the terminal device to switch from the second feedback mode to the first feedback mode for sending the HARQ feedback information, and the first field in the DCI may be set to 0 to indicate the terminal device to switch from the first feedback mode to the second feedback mode for sending the HARQ feedback information.

In some exemplary embodiments, an existing field in the DCI may be multiplexed to indicate the switching of the feedback mode. For example, a UL or SUL indication field in the DCI may be multiplexed to indicate the switching of the feedback mode, with the UL or SUL in the DCI being the first identification to indicate the terminal device to switch from the second feedback mode to the first feedback mode for sending the HARQ feedback information, and the UL or SUL in the DCI being the second identification to indicate the terminal device to switch from the first feedback mode to the second feedback mode for sending the HARQ feedback information.

In some exemplary embodiments, the UL or SUL indication field in the two formats DCI0_1/DCI0_2 may be specifically multiplexed to indicate the switching of the feedback mode, with the UL or SUL in the DCI0_1/DCI0_2 being the first identification to indicate the terminal device to switch from the second feedback mode to the first feedback mode for sending the HARQ feedback information, and the UL or SUL in the DCI0_1/DCI0_2 being the second identification to indicate the terminal device to switch from the first feedback mode to the second feedback mode for sending the HARQ feedback information.

For example, the UL or SUL in the DCI0_1/DCI0_2 may be set to 0 to indicate the terminal device to switch from the second feedback mode to the first feedback mode for sending the HARQ feedback information, and the UL or SUL in the DCI0_1/DCI0_2 may be set to 1 to indicate the terminal device to switch from the first feedback mode to the second feedback mode for sending the HARQ feedback information; or, similarly, the UL or SUL in the DCI0_1/DCI0_2 may be set to 1 to indicate the terminal device to switch from the second feedback mode to the first feedback mode for sending the HARQ feedback information, and the UL or SUL in the DCI0_1/DCI0_2 may be set to 0 to indicate the terminal device to switch from the first feedback mode to the second feedback mode for sending the HARQ feedback information.

Taking the first identification as 0 and the second identification as 1 as an example, i.e., when the UL or SUL in the DCI0_1/DCI0_2 is 1, the terminal device is indicated to switch from the first feedback mode to the second feedback mode for sending the HARQ feedback information, and when the terminal device sends the HARQ feedback information by using the first feedback mode, it is assumed that the UL or SUL in the DCI0_1/DCI0_2 received by the terminal device is 1, the terminal device may, based on the switching instruction, terminate the first feedback mode and switch to the second feedback mode for sending the HARQ feedback information.

In an embodiment of the present application, the switching instruction may also be DCI including a third identification. In some embodiments, when the DCI received by the terminal device includes the third identification, the terminal device is indicated to switch from the current feedback mode to another feedback mode, i.e., switch from the second feedback mode to the first feedback mode, or switch from the first feedback mode to the second feedback mode. In some embodiments, the third identification may be set as desired. For example, the third identification may be 1, or the third identification may be 0.

In some exemplary embodiments, a new field may be added to the DCI, such as a second field, and the second field is used to indicate the switching of the feedback mode. For example, when the second field in the DCI is the third identification, the switching of the feedback mode is indicated.

In some embodiments, the length of the newly added field may be 1 bit in order to save overhead. For example, the third identification may be set to 1 and the second field in the DCI may be set to 1 to indicate switching of the feedback mode; or, similarly, the third identification may be set to 0 and the second field in the DCI may be set to 0 to indicate switching of the feedback mode.

In some exemplary embodiments, an existing field in the DCI may be multiplexed to indicate the switching of the feedback mode. For example, a UL or SUL indication field in the DCI is multiplexed, or a carrier indication in the DCI is multiplexed for the switching of the feedback mode. For example, when the UL or SUL in the two formats DCI0_1/DCI0_2 is the third identification, the switching of the feedback mode is indicated.

For example, the terminal device may be indicated to switch the feedback mode when the UL or SUL in the DCI0_1/DCI0_2 is set to 0; or, similarly, the terminal device may be indicated to switch the feedback mode when the UL or SUL in the DCI0_1/DCI0_2 is set to 1.

Taking the third identification as 1 as an example, i.e., when the UL or SUL in the DCI0_1/DCI0_2 is 1, the terminal device is indicated to switch the feedback mode. When the terminal device sends the HARQ feedback information by using the first feedback mode, it is assumed that that the UL or SUL in the DCI0_1/DCI0_2 received by the terminal device is 1, the terminal device may, based on the switching instruction, terminate the first feedback mode and switch to the second feedback mode for sending the HARQ feedback information.

In some exemplary embodiments, after the terminal device generates the HARQ feedback information based on the downlink data, the terminal device may send the HARQ feedback information by default first by using the first feedback mode. For the terminal device that sends the HARQ feedback information by using the first feedback mode, upon receiving the switching instruction, the terminal device immediately terminates the first feedback mode and switches to the second feedback mode for sending the HARQ feedback information.

In summary, by receiving the downlink data, generating the HARQ feedback information based on the downlink data, sending the HARQ feedback information by default by using the first feedback mode, where the first feedback mode is the delayed feedback on the current carrier, and by receiving the switching instruction, terminating the first feedback mode, and switching to the second feedback mode for sending the HARQ feedback information, where the second feedback mode is the feedback on the switched candidate carrier, and the terminal device supports switching between the first feedback mode and the second feedback mode, the terminal device is enabled to switch the feedback mode based on the switching instruction, realizing switching the feedback mode flexibly as required to send the HARQ feedback information, avoiding the situation where the HARQ feedback information is discarded, and ensuring the reliability of the sending of the HARQ feedback information and the feedback efficiency.

Referring to FIG. 6, FIG. 6 is a schematic flowchart of a method for receiving an HARQ provided by an embodiment of the present application. It should be illustrated that the method for receiving an HARQ in the embodiment of the present application is performed by a network device. As shown in FIG. 6, the method may include the following steps 601 to 602.

At step 601, downlink data is sent to a terminal device.

At step 602, HARQ feedback information sent by the terminal device is received, where the HARQ feedback information is generated by the terminal device based on the downlink data, the HARQ feedback information is sent, by the terminal device based on a switching priority, by using a first feedback mode or a second feedback mode, the first feedback mode is delayed feedback on a current carrier, the second feedback mode is feedback on a switched candidate carrier, and switching between the first feedback mode and the second feedback mode is supported by the terminal device.

It can be understood that the network device may send the downlink data to the terminal device. The terminal device, after receiving the downlink data, may detect the downlink data for error correction and generate the HARQ feedback information based on the detecting result, and then send, based on the switching priority, the HARQ feedback information by using the first feedback mode or the second feedback mode. Accordingly, the network device may receive the HARQ feedback information that is generated by the terminal device based on the downlink data and is sent, by the terminal device based on the switching priority, by using the first feedback mode or the second feedback mode.

In some embodiments, the HARQ feedback information may be feedback information when the downlink data is correctly received or feedback information when the downlink data reception fails, and the present application does not make limitations to this.

In some embodiment, the current carrier refers to a carrier on which the terminal device receives PDSCH data and currently used by the terminal device to send the HARQ feedback information. The candidate carrier refers to a carrier, other than the current carrier, that the terminal device can use to send the HARQ feedback information.

In some embodiment, the first feedback mode is the delayed feedback on the current carrier, i.e., deferring the feedback of the HARQ feedback information to a next available feedback resource on the current carrier. The second feedback mode is the feedback on the switched candidate carrier. It should be illustrated that the candidate carrier that is switched to and is finally used to send the HARQ feedback information in the second feedback mode may be any one of a plurality of candidate carriers, for example, the number of candidate carriers may be 2 or 4, and the second feedback mode may be switching to any candidate carrier of the 2 or 4 candidate carriers and performing the feedback of the HARQ feedback information on the switched candidate carrier. In some embodiments, the feedback resource may refer to a PUCCH time frequency resource.

Additionally, the terminal device supports switching between the first feedback mode and the second feedback mode. In some embodiments, the switching refers to switching between the first feedback mode and the second feedback mode.

The switching priority may be understood as an execution order of the first feedback mode and the second feedback mode. In some embodiments, the switching priority may be agreed upon by a protocol, may be indicated by the network device, may be determined after deliberation between the terminal device and the network device, or may be determined by other means, and the present application does not make limitations to this.

In some exemplary embodiments, for example, the switching priority may be that the terminal device preferentially performs the feedback of the HARQ feedback information on the switched candidate carrier when there is an available candidate carrier, and the terminal device performs the delayed feedback on the current carrier when there is no available candidate carrier; or the switching priority may be that the terminal device performs the delayed feedback on the current carrier when there is an available feedback resource on the current carrier, and the terminal device performs the feedback on the switched candidate carrier when there is no available feedback resource found on the current carrier. As a result, the network device receives the HARQ feedback information sent by the terminal device by using the first feedback mode or the second feedback mode based on the switching priority, this enables each piece of HARQ feedback information can be sent by the terminal device to the network device in a timely and reliable manner through flexibly switching of the feedback mode, thereby avoiding the situation where the HARQ feedback information is discarded, and ensuring the reliability of the sending of the HARQ feedback information and the feedback efficiency.

In summary, through sending the downlink data by the network device to the terminal device, and receiving the HARQ feedback information sent by the terminal device, where the HARQ feedback information is generated by the terminal device based on the downlink data, the HARQ feedback information is sent, by the terminal device based on the switching priority, by using the first feedback mode or the second feedback mode, the first feedback mode is the delayed feedback on the current carrier, the second feedback mode is the feedback on the switched candidate carrier, and switching between the first feedback mode and the second feedback mode is supported by the terminal device, the terminal device is enabled to switch the feedback mode flexibly as required to send the HARQ feedback information to the network device, avoiding the situation where the HARQ feedback information is discarded, and ensuring the reliability of the sending of the HARQ feedback information and the feedback efficiency.

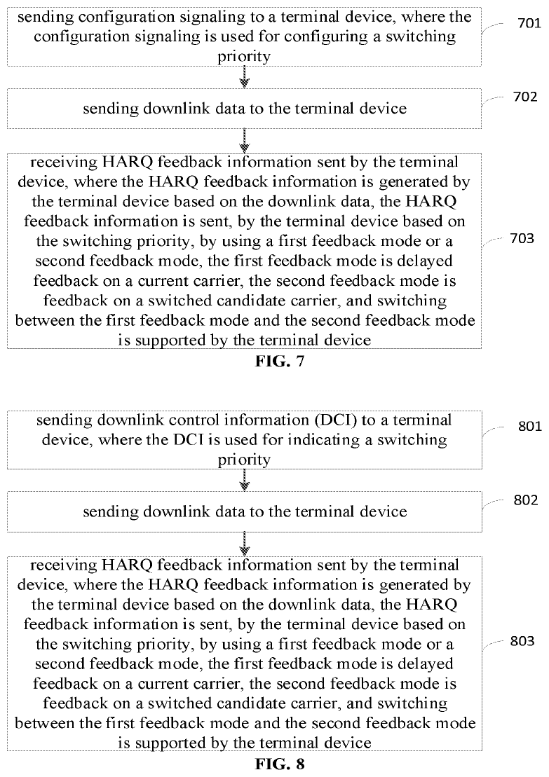

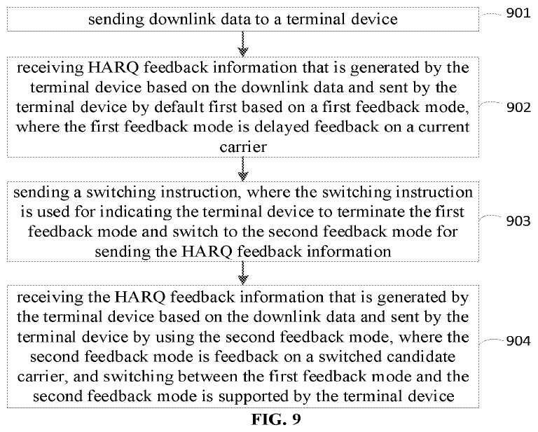

Referring to FIG. 7, FIG. 7 is a schematic flowchart of a method for receiving an HARQ provided by an embodiment of the present application. It should be illustrated that the method for receiving an HARQ in the embodiment of the present application may be performed by a network device, and the method for receiving an HARQ may be executed alone, may be executed in combination with any one of the embodiments of the present disclosure or possible implementations of the embodiments of the present disclosure, or may be executed in combination with any one of the technical solutions in the related art. As shown in FIG. 7, the method may include the following steps 701 to 703.

At step 701, configuration signaling is sent to a terminal device, where the configuration signaling is used for configuring a switching priority.

In some embodiments, the switching priority may be understood as an execution order of a first feedback mode and a second feedback mode. Herein, the description of the first feedback mode and the second feedback mode may be referred to the description of the above embodiments and will not be repeated herein.

Additionally, the terminal device supports switching between the first feedback mode and the second feedback mode. In some embodiments, the switching refers to switching between the first feedback mode and the second feedback mode.

It can be understood that the switching priority may be sent to the terminal device by the network device. Specifically, the network device may send the configuration signaling to the terminal device, and the configuration signaling is used for configuring the switching priority, such that the terminal device may determine the switching priority of the first feedback mode and the second feedback mode based on the configuration signaling as received.

In some exemplary embodiments, the configuration signaling may be RRC signaling.

In some exemplary embodiments, the switching priority may be configured by means of semi-static configuration. For example, the network device may send the configuration signaling to the terminal device at a long period; or the switching priority may be configured by other means, and the present application does not make limitations to this.

At step 702, downlink data is sent to the terminal device.

At step 703, HARQ feedback information sent by the terminal device is received, where the HARQ feedback information is generated by the terminal device based on the downlink data, the HARQ feedback information is sent, by the terminal device based on the switching priority, by using the first feedback mode or the second feedback mode, the first feedback mode is delayed feedback on a current carrier, the second feedback mode is feedback on a switched candidate carrier, and switching between the first feedback mode and the second feedback mode is supported by the terminal device.

It can be understood that the network device may send the downlink data to the terminal device. The terminal device, after receiving the downlink data, may detect the downlink data for error correction and generate the HARQ feedback information based on the detecting result, and then send, based on the switching priority, the HARQ feedback information by using the first feedback mode or the second feedback mode. Accordingly, the network device may receive the HARQ feedback information that is generated by the terminal device based on the downlink data and is sent, by the terminal device based on the switching priority, by using the first feedback mode or the second feedback mode.

It should be illustrated that step 701 may be executed before step 702, may be executed at the same time as step 702, or may be executed after step 702, and the present application does not limit the timing of the execution of step 701. The embodiment of the present application is illustrated by taking the execution of step 701 before step 702 as an example.

In an embodiment of the present application, the switching priority may be: if a condition for the second feedback mode is satisfied, preferentially using the second feedback mode for feedback; if not, using the first feedback mode for feedback. The condition for the second feedback mode refers to that the terminal device has a carrier, other than the current carrier, that can be used to send the HARQ feedback information.

Specifically, when sending the HARQ feedback information based on this switching priority, if the terminal device has a candidate carrier, other than the current carrier, that can be used to send the HARQ feedback information, the terminal device may preferentially switch to the candidate carrier and perform the feedback of the HARQ feedback information on the switched candidate carrier; if the terminal device does not have a candidate carrier, other than the current carrier, that can be used to send the HARQ feedback information, the terminal device may defer the feedback of the HARQ feedback information to a next available feedback resource on the current carrier.

In an embodiment of the present application, the switching priority may be: if a condition for the first feedback mode is satisfied, preferentially using the first feedback mode for feedback; if no available feedback resource is found on the current carrier, switching to the candidate carrier by using the second feedback mode, where using the first feedback mode for feedback is further supported on the candidate carrier. In some embodiments, the feedback resource may refer to a PUCCH time frequency resource. The condition for the first feedback mode refers to that there is an available feedback resource on the current carrier. Using the first feedback mode for feedback being further supported on the candidate carrier refers to that delayed feedback of the HARQ feedback information may be performed on the candidate carrier.

Specifically, when sending the HARQ feedback information based on this switching priority, if there is an available feedback resource on the current carrier, the terminal device preferentially defers the feedback of the HARQ feedback information to a next available feedback resource, and if no available feedback resource is found on the current carrier, the terminal device switches to the candidate carrier and performs the feedback of the HARQ feedback information on the switched candidate carrier. Further, when switching to the candidate carrier for the feedback of the HARQ feedback information, if still no available feedback resource is found on the candidate carrier, the terminal device may defer the feedback of the HARQ feedback information to a next available feedback resource on the candidate carrier.

In an embodiment of the present application, the switching priority may be: if a condition for the first feedback mode is satisfied, preferentially using the first feedback mode for feedback; if no available feedback resource is found on the current carrier, switching to the candidate carrier by using the second feedback mode, where using the first feedback mode for feedback is not further supported on the candidate carrier. In some embodiments, the feedback resource may refer to a PUCCH time frequency resource. The condition for the first feedback mode refers to that there is an available feedback resource on the current carrier. Using the first feedback mode for feedback being not further supported on the candidate carrier refers to that delayed feedback of the HARQ feedback information cannot be performed on the candidate carrier.

Specifically, when sending the HARQ feedback information based on this switching priority, if there is an available feedback resource on the current carrier, the terminal device preferentially defers the feedback of the HARQ feedback information to a next available feedback resource, and if no available feedback resource is found on the current carrier, the terminal device switches to the candidate carrier and performs the feedback of the HARQ feedback information on the switched candidate carrier. Further, when switching to the candidate carrier for the feedback of the HARQ feedback information, if still no available feedback resource is found on the candidate carrier, the terminal device may further switch to another candidate carrier for feedback as using the first feedback mode for feedback is not further supported on the candidate carrier. By sending the HARQ feedback information based on this switching priority, algorithm complexity is reduced, and resources are saved.

As a result, each piece of HARQ feedback information can be sent by the terminal device to the network device in a timely and reliable manner through flexibly switching of the feedback mode, thereby avoiding the situation where the HARQ feedback information is discarded, and ensuring the reliability of the sending of the HARQ feedback information and the feedback efficiency.

In summary, through sending the configuration signaling by the network device to the terminal device, where the configuration signaling is used for configuring the switching priority, sending the downlink data to the terminal device, and receiving the HARQ feedback information sent by the terminal device, where the HARQ feedback information is generated by the terminal device based on the downlink data, the HARQ feedback information is sent, by the terminal device based on the switching priority, by using the first feedback mode or the second feedback mode, the first feedback mode is the delayed feedback on the current carrier, the second feedback mode is the feedback on the switched candidate carrier, and switching between the first feedback mode and the second feedback mode is supported by the terminal device, the terminal device is enabled to switch the feedback mode flexibly as required to send the HARQ feedback information to the network device, avoiding the situation where the HARQ feedback information is discarded, and ensuring the reliability of the sending of the HARQ feedback information and the feedback efficiency.

Referring to FIG. 8, FIG. 8 is a schematic flowchart of a method for receiving an HARQ provided by an embodiment of the present application. It should be illustrated that the method for receiving an HARQ in the embodiment of the present application may be performed by a network device, and the method for receiving an HARQ may be executed alone, may be executed in combination with any one of the embodiments of the present disclosure or possible implementations of the embodiments of the present disclosure, or may be executed in combination with any one of the technical solutions in the related art. As shown in FIG. 8, the method may include the following steps 801 to 803.

At step 801, DCI is sent to a terminal device, where the DCI is used for indicating a switching priority.

In some embodiments, the switching priority may be understood as an execution order of a first feedback mode and a second feedback mode. Herein, the description of the first feedback mode and the second feedback mode may be referred to the description of the above embodiments and will not be repeated herein.

Additionally, the terminal device supports switching between the first feedback mode and the second feedback mode. In some embodiments, the switching refers to switching between the first feedback mode and the second feedback mode.

It can be understood that the switching priority may be sent to the terminal device by the network device. Specifically, the network device may send the DCI to the terminal device, and the DCI is used for indicating the switching priority, such that the terminal device may determine the switching priority of the first feedback mode and the second feedback mode based on the DCI as received.

At step 802, downlink data is sent to the terminal device.

At step 803, HARQ feedback information sent by the terminal device is received, where the HARQ feedback information is generated by the terminal device based on the downlink data, the HARQ feedback information is sent, by the terminal device based on the switching priority, by using the first feedback mode or the second feedback mode, the first feedback mode is delayed feedback on a current carrier, the second feedback mode is feedback on a switched candidate carrier, and switching between the first feedback mode and the second feedback mode is supported by the terminal device.

It can be understood that the network device may send the downlink data to the terminal device. The terminal device, after receiving the downlink data, may detect the downlink data for error correction and generate the HARQ feedback information based on the detecting result, and then send, based on the switching priority, the HARQ feedback information by using the first feedback mode or the second feedback mode. Accordingly, the network device may receive the HARQ feedback information that is generated by the terminal device based on the downlink data and is sent, by the terminal device based on the switching priority, by using the first feedback mode or the second feedback mode.

It should be illustrated that step 801 may be executed before step 802, may be executed at the same time as step 802, or may be executed after step 802, and the present application does not limit the timing of the execution of step 801. The embodiment of the present application is illustrated by taking the execution of step 801 before step 802 as an example.

In an embodiment of the present application, the switching priority may be: when the DCI includes a first identification, sending the HARQ feedback information by using the first feedback mode; when the DCI includes a second identification, sending the HARQ feedback information by using the second feedback mode. In some embodiments, the first identification and the second identification may be set as desired. For example, the first identification may be 1, and the second identification may be 0; or the first identification may be 0, and the second identification may be 1.

In some exemplary embodiments, a new field may be added to the DCI, such as a first field, and the first field is used to indicate the switching priority. The HARQ feedback information is sent by using the first feedback mode when the first field in the DCI is the first identification, and the HARQ feedback information is sent by using the second feedback mode when the first field in the DCI is the second identification.

In some embodiments, the length of the newly added field may be 1 bit in order to save overhead. For example, the first field in the DCI may be set to 0 to indicate sending the HARQ feedback information by using the first feedback mode, and the first field in the DCI may be set to 1 to indicate sending the HARQ feedback information by using the second feedback mode; or, similarly, the first field in the DCI may be set to 1 to indicate sending the HARQ feedback information by using the first feedback mode, and the first field in the DCI may be set to 0 to indicate sending the HARQ feedback information by using the second feedback mode.

In some exemplary embodiments, an existing field in the DCI may be multiplexed to indicate the switching priority. For example, a UL or SUL indication field in the DCI may be multiplexed to indicate the switching priority, with the UL or SUL in the DCI being the first identification to indicate sending the HARQ feedback information by using the first feedback mode, and the UL or SUL in the DCI being the second identification to indicate sending the HARQ feedback information by using the second feedback mode. In some embodiments, the field length of the UL/SUL in the DCI is 1 bit.

In some exemplary embodiments, the UL or SUL indication field in the two formats DCI0_1/DCI0_2 may be specifically multiplexed to indicate the switching priority, with the UL or SUL in the DCI0_1/DCI0_2 being the first identification to indicate sending the HARQ feedback information by using the first feedback mode, and the UL or SUL in the DCI0_1/DCI0_2 being the second identification to indicate sending the HARQ feedback information by using the second feedback mode.

For example, the UL or SUL in the DCI0_1/DCI0_2 may be set to 0 to indicate sending the HARQ feedback information by using the first feedback mode, and the UL or SUL in the DCI0_1/DCI0_2 may be set to 1 to indicate sending the HARQ feedback information by using the second feedback mode; or, similarly, the UL or SUL in the DCI0_1/DCI0_2 may be set to 1 to indicate sending the HARQ feedback information by using the first feedback mode, and the UL or SUL in the DCI0_1/DCI0_2 may be set to 0 to indicate sending the HARQ feedback information by using the second feedback mode.

Taking the first identification as 0 and the second identification as 1 as an example, when sending the HARQ feedback information based on the above switching priority, if the UL or SUL in the DCI received by the terminal device is 1, the terminal device may switch to the candidate carrier and perform the feedback of the HARQ feedback information on the switched candidate carrier, and if the UL or SUL in the DCI received by the terminal device is 0, the terminal device may defer the feedback of the HARQ feedback information to a next available feedback resource on the current carrier.

As a result, each piece of HARQ feedback information can be sent by the terminal device to the network device in a timely and reliable manner through flexibly switching of the feedback mode, thereby avoiding the situation where the HARQ feedback information is discarded, and ensuring the reliability of the sending of the HARQ feedback information and the feedback efficiency.

In summary, through sending the DCI by the network device to the terminal device, where the DCI is used for indicating the switching priority, sending the downlink data to the terminal device, and receiving the HARQ feedback information sent by the terminal device, where the HARQ feedback information is generated by the terminal device based on the downlink data, the HARQ feedback information is sent, by the terminal device based on the switching priority, by using the first feedback mode or the second feedback mode, the first feedback mode is the delayed feedback on the current carrier, the second feedback mode is the feedback on the switched candidate carrier, and switching between the first feedback mode and the second feedback mode is supported by the terminal device, the terminal device is enabled to switch the feedback mode flexibly as required to send the HARQ feedback information to the network device, avoiding the situation where the HARQ feedback information is discarded, and ensuring the reliability of the sending of the HARQ feedback information and the feedback efficiency.

Referring to FIG. 9, FIG. 9 is a schematic flowchart of a method for receiving an HARQ provided by an embodiment of the present application. It should be illustrated that the method for receiving an HARQ in the embodiment of the present application may be performed by a network device, and the method for receiving an HARQ may be executed alone, may be executed in combination with any one of the embodiments of the present disclosure or possible implementations of the embodiments of the present disclosure, or may be executed in combination with any one of the technical solutions in the related art. As shown in FIG. 9, the method may include the following steps 901 to 904.

At step 901, downlink data is sent to a terminal device.

At step 902, HARQ feedback information that is generated by the terminal device based on the downlink data and sent by the terminal device by default first based on a first feedback mode is received, where the first feedback mode is delayed feedback on a current carrier.

It can be understood that the network device may send the downlink data to the terminal device. The terminal device, after receiving the downlink data, may detect the downlink data for error correction and generate the HARQ feedback information based on the detecting result, and then send the HARQ feedback information by default first based on the first feedback mode. Accordingly, the network device may receive the HARQ feedback information that is generated by the terminal device based on the downlink data and sent by the terminal device by default first based on the first feedback mode.

Additionally, the terminal device supports switching between the first feedback mode and the second feedback mode. In some embodiments, the switching refers to switching between the first feedback mode and the second feedback mode.

Herein, the description of the first feedback mode and the second feedback mode may be referred to the description of the above embodiments and will not be repeated herein.

At step 903, a switching instruction is sent, where the switching instruction is used for indicating the terminal device to terminate the first feedback mode and switch to the second feedback mode for sending the HARQ feedback information.

At step 904, the HARQ feedback information that is generated by the terminal device based on the downlink data and sent by the terminal device by using the second feedback mode is received, where the second feedback mode is feedback on a switched candidate carrier, and switching between the first feedback mode and the second feedback mode is supported by the terminal device.

In some embodiments, the switching instruction is used for indicating the terminal device to switch the feedback mode of the HARQ feedback information. Specifically, when the terminal device sends the HARQ feedback information by using the first feedback mode, the switching instruction is used for indicating the terminal device to terminate the first feedback mode and switch to the second feedback mode for sending the HARQ feedback information.

In an embodiment of the present application, the switching instruction may be DCI including a first identification or a second identification. In some embodiments, when the DCI sent by the network device to the terminal device includes the first identification, the terminal device is indicated to switch from the second feedback mode to the first feedback mode for sending the HARQ feedback information; and when the DCI sent by the network device to the terminal device includes the second identification, the terminal device is indicated to switch from the first feedback mode to the second feedback mode for sending the HARQ feedback information. In some embodiments, the first identification and the second identification may be set as desired. For example, the first identification may be 1, and the second identification may be 0; or the first identification may be 0, and the second identification may be 1.

In some exemplary embodiments, a new field may be added to the DCI, such as a first field, and the first field is used to indicate the switching of the feedback mode. The terminal device is indicated to switch from the second feedback mode to the first feedback mode for sending the HARQ feedback information when the first field in the DCI is the first identification, and terminal device is indicated to switch from the first feedback mode to the second feedback mode for sending the HARQ feedback information when the first field in the DCI is the second identification.

In some embodiments, the length of the newly added field may be 1 bit in order to save overhead. For example, the first field in the DCI may be set to 0 to indicate the terminal device to switch from the second feedback mode to the first feedback mode for sending the HARQ feedback information, and the first field in the DCI may be set to 1 to indicate the terminal device to switch from the first feedback mode to the second feedback mode for sending the HARQ feedback information; or, similarly, the first field in the DCI may be set to 1 to indicate the terminal device to switch from the second feedback mode to the first feedback mode for sending the HARQ feedback information, and the first field in the DCI may be set to 0 to indicate the terminal device to switch from the first feedback mode to the second feedback mode for sending the HARQ feedback information.

In some exemplary embodiments, an existing field in the DCI may be multiplexed to indicate the switching of the feedback mode. For example, a UL or SUL indication field in the DCI may be multiplexed to indicate the switching of the feedback mode, with the UL or SUL in the DCI being the first identification to indicate the terminal device to switch from the second feedback mode to the first feedback mode for sending the HARQ feedback information, and the UL or SUL in the DCI being the second identification to indicate the terminal device to switch from the first feedback mode to the second feedback mode for sending the HARQ feedback information.

In some exemplary embodiments, the UL or SUL indication field in the two formats DCI0_1/DCI0_2 may be specifically multiplexed to indicate the switching of the feedback mode, with the UL or SUL in the DCI0_1/DCI0_2 being the first identification to indicate the terminal device to switch from the second feedback mode to the first feedback mode for sending the HARQ feedback information, and the UL or SUL in the DCI0_1/DCI0_2 being the second identification to indicate the terminal device to switch from the first feedback mode to the second feedback mode for sending the HARQ feedback information.

For example, the UL or SUL in the DCI0_1/DCI0_2 may be set to 0 to indicate the terminal device to switch from the second feedback mode to the first feedback mode for sending the HARQ feedback information, and the UL or SUL in the DCI0_1/DCI0_2 may be set to 1 to indicate the terminal device to switch from the first feedback mode to the second feedback mode for sending the HARQ feedback information; or, similarly, the UL or SUL in the DCI0_1/DCI0_2 may be set to 1 to indicate the terminal device to switch from the second feedback mode to the first feedback mode for sending the HARQ feedback information, and the UL or SUL in the DCI0_1/DCI0_2 may be set to 0 to indicate the terminal device to switch from the first feedback mode to the second feedback mode for sending the HARQ feedback information.

Taking the first identification as 0 and the second identification as 1 as an example, i.e., when the UL or SUL in the DCI0_1/DCI0_2 is 1, the terminal device is indicated to switch from the first feedback mode to the second feedback mode for sending the HARQ feedback information, and when the terminal device generates the HARQ feedback information based on the downlink data and sends the HARQ feedback information by using the first feedback mode, the network device may send the switching instruction to the terminal device. It is assumed that the UL or SUL in the DCI0_1/DCI0_2 sent by the network device to the terminal device is 1, the terminal device may, based on the switching instruction, terminate the first feedback mode and switch to the second feedback mode for sending the HARQ feedback information. Accordingly, the network device may receive the HARQ feedback information that is generated by the terminal device based on the downlink data and sent by the terminal device by using the second feedback mode.

In an embodiment of the present application, the switching instruction may also be DCI including a third identification. In some embodiments, when the DCI sent by the network device to the terminal device includes the third identification, the terminal device is indicated to switch from the current feedback mode to another feedback mode, i.e., switch from the second feedback mode to the first feedback mode, or switch from the first feedback mode to the second feedback mode. In some embodiments, the third identification may be set as desired. For example, the third identification may be 1, or the third identification may be 0.

In some exemplary embodiments, a new field may be added to the DCI, such as a second field, and the second field is used to indicate the switching of the feedback mode. For example, when the second field in the DCI is the third identification, the switching of the feedback mode is indicated.

In some embodiments, the length of the newly added field may be 1 bit in order to save overhead. For example, the third identification may be set to 1 and the second field in the DCI may be set to 1 to indicate switching of the feedback mode; or, similarly, the third identification may be set to 0 and the second field in the DCI may be set to 0 to indicate switching of the feedback mode.

In some exemplary embodiments, an existing field in the DCI may be multiplexed to indicate the switching of the feedback mode. For example, a UL or SUL indication field in the DCI is multiplexed, or a carrier indication in the DCI is multiplexed for the switching of the feedback mode. For example, when the UL or SUL in the two formats DCI0_1/DCI0_2 is the third identification, the switching of the feedback mode is indicated.

For example, the terminal device may be indicated to switch the feedback mode when the UL or SUL in the DCI0_1/DCI0_2 is set to 0; or, similarly, the terminal device may be indicated to switch the feedback mode when the UL or SUL in the DCI0_1/DCI0_2 is set to 1.

Taking the third identification as 1 as an example, i.e., when the UL or SUL in the DCI0_1/DCI0_2 is 1, the terminal device is indicated to switch the feedback mode. When the terminal device generates the HARQ feedback information based on the downlink data and sends the HARQ feedback information by using the first feedback mode, the network device may send the switching instruction to the terminal device. Assuming that the UL or SUL in the DCI0_1/DCI0_2 sent by the network device to the terminal device is 1, the terminal device may, based on the switching instruction, terminate the first feedback mode and switch to the second feedback mode for sending the HARQ feedback information. Accordingly, the network device may receive the HARQ feedback information that is generated by the terminal device based on the downlink data and sent by the terminal device by using the second feedback mode.

In some exemplary embodiments, after the terminal device generates the HARQ feedback information based on the downlink data, the terminal device may first send the HARQ feedback information by using the first feedback mode by default, and the network device may send the switching instruction to the terminal device after receiving the HARQ feedback information sent by the terminal device by using the first feedback mode. The terminal device, upon receiving the switching instruction, immediately terminates the first feedback mode and switches to the second feedback mode for sending the HARQ feedback information. Accordingly, the network device may receive the HARQ feedback information that is generated by the terminal device based on the downlink data and sent by the terminal device by using the second feedback mode.

In summary, through sending the downlink data by the network device to the terminal device, receiving the HARQ feedback information that is generated by the terminal device based on the downlink data and sent by the terminal device by default first based on the first feedback mode, where the first feedback mode is the delayed feedback on the current carrier, sending the switching instruction, where the switching instruction is used for indicating the terminal device to terminate the first feedback mode and switch to the second feedback mode for sending the HARQ feedback information, and receiving the HARQ feedback information that is generated by the terminal device based on the downlink data and sent by the terminal device by using the second feedback mode, where the second feedback mode is the feedback on the switched candidate carrier, and switching between the first feedback mode and the second feedback mode is supported by the terminal device, the terminal device is enabled to switch the feedback mode based on the switching instruction, realizing that the terminal device switches the feedback mode flexibly as required to send the HARQ feedback information to the network device, avoiding the situation where the HARQ feedback information is discarded, and ensuring the reliability of the sending of the HARQ feedback information and the feedback efficiency.

Corresponding to the method for sending an HARQ provided in the above embodiments, the present application also provides an apparatus for sending an HARQ. Since the apparatus for sending an HARQ provided in the embodiments of the present application corresponds to the method for sending an HARQ provided in the above embodiments, the embodiments of the method for sending an HARQ are also applicable to the apparatus for sending an HARQ provided by the following embodiments, which will not be described in detail in the following embodiments.

Referring to FIG. 10, FIG. 10 is a schematic diagram of a structure of an apparatus for sending an HARQ applied to a terminal device provided in an embodiment of the present application.

As shown in FIG. 10, the apparatus 1000 for sending an HARQ includes a transceiving unit 1010 and a processing unit 1020.

The transceiving unit 1010 is configured to receive downlink data.

The processing unit 1020 is configured to generate HARQ feedback information based on the downlink data and send, based on a switching priority, the HARQ feedback information by using a first feedback mode or a second feedback mode, where the first feedback mode is delayed feedback on a current carrier, the second feedback mode is feedback on a switched candidate carrier, and the terminal device supports switching between the first feedback mode and the second feedback mode.

Optionally, the transceiving unit 1010 is further configured to receive configuration signaling sent by a network device, where the configuration signaling is used for configuring the switching priority.

Optionally, the configuration signaling is RRC signaling.

Optionally, the switching priority may be: if a condition for the second feedback mode is satisfied, preferentially using the second feedback mode for feedback; if not, using the first feedback mode for feedback.

Optionally, the switching priority may be: if a condition for the first feedback mode is satisfied, preferentially using the first feedback mode for feedback; if no available feedback resource is found on the current carrier, switching to the candidate carrier by using the second feedback mode, where using the first feedback mode for feedback is further supported on the candidate carrier.

Optionally, the switching priority may be: if a condition for the first feedback mode is satisfied, preferentially using the first feedback mode for feedback; if no available feedback resource is found on the current carrier, switching to the candidate carrier by using the second feedback mode, where using the first feedback mode for feedback is not further supported on the candidate carrier.

Optionally, the transceiving unit 1010 is further configured to receive DCI sent by a network device, where the DCI is used for indicating the switching priority.

Optionally, the switching priority is: when the DCI includes a first identification, sending the HARQ feedback information by using the first feedback mode; when the DCI includes a second identification, sending the HARQ feedback information by using the second feedback mode.

Optionally, the switching priority may be: when a UL or an SUL in the DCI is the first identification, sending the HARQ feedback information by using the first feedback mode; when the UL or the SUL in the DCI is the second identification, sending the HARQ feedback information by using the second feedback mode.

Optionally, the transceiving unit 1010 is further configured to receive a switching instruction; and the processing unit is further configured to, when the HARQ feedback information is sent by using the first feedback mode and the switching instruction is received, terminate the first feedback mode, and switch to the second feedback mode for sending the HARQ feedback information.

In the apparatus for sending an HARQ in the embodiment of the present application, by receiving the downlink data, generating the HARQ feedback information based on the downlink data, and sending, based on the switching priority, the HARQ feedback information by using the first feedback mode or the second feedback mode, where the first feedback mode is the delayed feedback on the current carrier, the second feedback mode is the feedback on the switched candidate carrier, and the terminal device supports switching between the first feedback mode and the second feedback mode, the terminal device is enabled to switch the feedback mode flexibly as required to send the HARQ feedback information, avoiding the situation where the HARQ feedback information is discarded, and ensuring the reliability of the sending of the HARQ feedback information and the feedback efficiency.

Corresponding to the method for receiving an HARQ provided in the above embodiments, the present application also provides an apparatus for receiving an HARQ. Since the apparatus for receiving an HARQ provided in the embodiments of the present application corresponds to the method for receiving an HARQ provided in the above embodiments, the embodiments of the method for receiving an HARQ are also applicable to the apparatus for receiving an HARQ provided by the following embodiments, which will not be described in detail in the following embodiments.

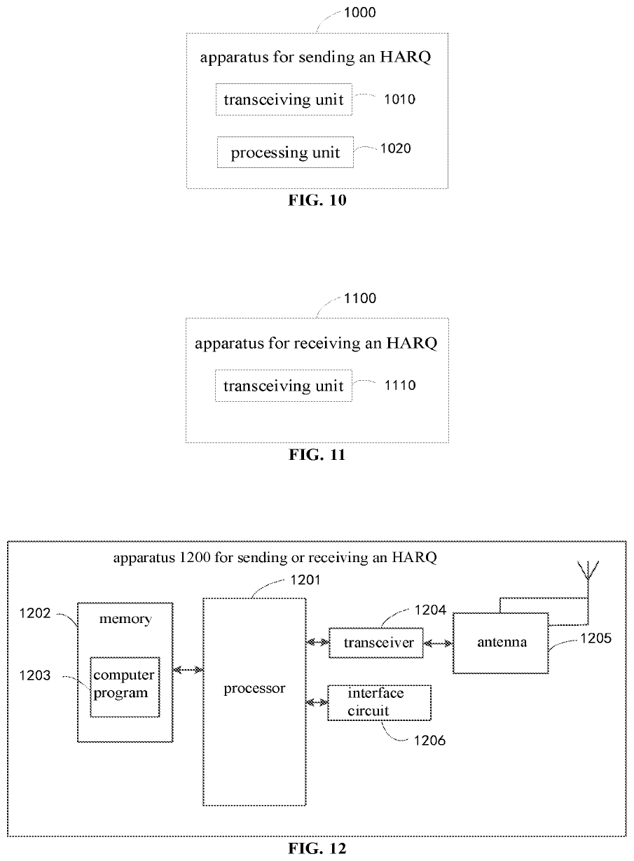

Referring to FIG. 11, FIG. 11 is a schematic diagram of a structure of an apparatus for receiving an HARQ applied to a network device provided in an embodiment of the present application.

As shown in FIG. 11, the apparatus 1100 for receiving an HARQ includes a transceiving unit 1110.

The transceiving unit 1110 is configured to send downlink data to a terminal device, and receive HARQ feedback information sent by the terminal device, where the HARQ feedback information is generated by the terminal device based on the downlink data.

In this embodiment, the HARQ feedback information is sent, by the terminal device based on a switching priority, by using a first feedback mode or a second feedback mode, where the first feedback mode is delayed feedback on a current carrier, the second feedback mode is feedback on a switched candidate carrier, and switching between the first feedback mode and the second feedback mode is supported by the terminal device.

Optionally, the transceiving unit 1110 is further configured to send configuration signaling to the terminal device, where the configuration signaling is used for configuring the switching priority.

Optionally, the configuration signaling is RRC signaling.

Optionally, the switching priority may be: if a condition for the second feedback mode is satisfied, preferentially using the second feedback mode for feedback; if not, using the first feedback mode for feedback.

Optionally, the switching priority may be: if a condition for the first feedback mode is satisfied, preferentially using the first feedback mode for feedback; if no available feedback resource is found on the current carrier, switching to the candidate carrier by using the second feedback mode, where using the first feedback mode for feedback is further supported on the candidate carrier.

Optionally, the switching priority may be: if a condition for the first feedback mode is satisfied, preferentially using the first feedback mode for feedback; if no available feedback resource is found on the current carrier, switching to the candidate carrier by using the second feedback mode, where using the first feedback mode for feedback is not further supported on the candidate carrier.

Optionally, the transceiving unit 1110 is further configured to send DCI to the terminal device, where the DCI is used for indicating the switching priority.

Optionally, the switching priority is: when the DCI includes a first identification, sending the HARQ feedback information by using the first feedback mode; when the DCI includes a second identification, sending the HARQ feedback information by using the second feedback mode.

Optionally, the switching priority may be: when a UL or an SUL in the DCI is the first identification, sending the HARQ feedback information by using the first feedback mode; when the UL or the SUL in the DCI is the second identification, sending the HARQ feedback information by using the second feedback mode.

Optionally, the transceiving unit is further configured to send a switching instruction, where the switching instruction is used for indicating the terminal device to terminate the first feedback mode and switch to the second feedback mode for sending the HARQ feedback information.

In the apparatus for receiving an HARQ provided in this embodiment, by sending the downlink data to the terminal device, and receiving the HARQ feedback information sent by the terminal device, where the HARQ feedback information is generated by the terminal device based on the downlink data, the HARQ feedback information is sent, by the terminal device based on the switching priority, by using the first feedback mode or the second feedback mode, the first feedback mode is the delayed feedback on the current carrier, the second feedback mode is the feedback on the switched candidate carrier, and switching between the first feedback mode and the second feedback mode is supported by the terminal device, the terminal device is enabled to switch the feedback mode flexibly as required to send the HARQ feedback information to the network device, avoiding the situation where the HARQ feedback information is discarded, and ensuring the reliability of the sending of the HARQ feedback information and the feedback efficiency.

In order to implement the above embodiments, an embodiment of the present application also proposes a communication device. The communication device includes a processor and a memory. The memory stores a computer program, and the processor executes the computer program stored in the memory to cause the device to perform the method as shown in the embodiments of FIG. 2 to FIG. 5.

In order to implement the above embodiments, an embodiment of the present application also proposes a communication device. The communication device includes a processor and a memory. The memory stores a computer program, and the processor executes the computer program stored in the memory to cause the device to perform the method as shown in the embodiments of FIG. 6 to FIG. 9.

In order to implement the above embodiments, an embodiment of the present application also proposes a communication device. The communication device includes a processor and an interface circuit. The interface circuit is configured to receive a code instruction and transmit the code instruction to the processor. The processor is configured to run the code instruction to perform the method as shown in the embodiments of FIG. 2 to FIG. 5.

In order to implement the above embodiments, an embodiment of the present application also proposes a communication device. The communication device includes a processor and an interface circuit. The interface circuit is configured to receive a code instruction and transmit the code instruction to the processor. The processor is configured to run the code instruction to perform the method as shown in the embodiments of FIG. 6 to FIG. 9.

Referring to FIG. 12, FIG. 12 is a schematic diagram of a structure of another apparatus for sending or receiving an HARQ provided by an embodiment of the present application. The apparatus 1200 for sending or receiving an HARQ may be a network device, a terminal device, or a chip, a chip system or a processor, etc. that supports a network device to implement the above-described method, or the apparatus 1200 for sending or receiving an HARQ may be a chip, a chip system or a processor, etc. that supports a terminal device to implement the above-described method. The apparatus may be configured to implement the method described in the above method embodiments. For details, please refer to the illustration in the above method embodiments.

The apparatus 1200 for sending or receiving an HARQ may include one or more processors 1201. The processor 1201 may be a general purpose processor or a specialized processor, etc. For example, the processor 1201 may be a baseband processor or a central processor. The baseband processor may be configured to process a communication protocol and communication data. The central processor may be configured to control the apparatus for sending or receiving an HARQ (e.g., a base station, a baseband chip, a terminal device, a terminal device chip, a DU, or a CU, etc.), execute a computer program, and process data of the computer program.

Optionally, the apparatus 1200 for sending or receiving an HARQ may further include one or more memories 1202. The one or more memories 1202 may store a computer program 1203. The processor 1201 executes the computer program 1203 to cause the apparatus 1200 for sending or receiving an HARQ to perform the method described in the above method embodiments. The computer program 1203 may be solidified in the processor 1201, in which case the processor 1201 may be implemented by hardware.

Optionally, the memory 1202 may also store data. The apparatus 1200 for sending or receiving an HARQ and the memory 1202 may be provided separately or may be integrated together.

Optionally, the apparatus 1200 for sending or receiving an HARQ may further include a transceiver 1204 and an antenna 1205. The transceiver 1204 may be referred to as a transceiver unit, a transceiver device, or a transceiver circuit, etc., and is configured to implement the receiving and sending functions. The transceiver 1204 may include a receiver and a sender. The receiver may be referred to as a receiving device or a receiving circuit, etc., and is configured to implement the receiving function. The sender may be referred to as a sending device or a sending circuit, etc., and is configured to implement the sending function.

Optionally, the apparatus 1200 for sending or receiving an HARQ may further include one or more interface circuits 1206. The interface circuit 1206 is configured to receive a code instruction and transmit the code instruction to the processor 1201. The processor 1201 runs the code instruction to cause the apparatus 1200 for sending or receiving an HARQ to perform the method described in the above method embodiments.

The apparatus 1200 for sending or receiving an HARQ is a terminal device; the transceiver 1204 is configured to perform steps 201 and 203 in FIGS. 2, 301, 302 and 304 in FIGS. 3, 401, 402 and 404 in FIG. 4, and 501, 503 and 504 in FIG. 5; and the processor 1201 is configured to perform steps 202 in FIG. 2, 303 in FIG. 3, 403 in FIG. 4, and 502 and 505 in FIG. 5.

The apparatus 1200 for sending or receiving an HARQ is a network device; and the transceiver 1204 is configured to perform steps 601 and 602 in FIG. 6, 701-703 in FIG. 7, 801-803 in FIG. 8, and 901-904 in FIG. 9.

In an embodiment, the processor 1201 may include a transceiver configured to implement the receiving and sending functions. For example, the transceiver may be a transceiver circuit, an interface, or an interface circuit. The transceiver circuit, interface, or interface circuit used for implementing the receiving and sending functions may be separate or may be integrated together. The transceiver circuit, interface, or interface circuit described above may be used for code/data reading and writing, or the transceiver circuit, interface, or interface circuit described above may be used for signal transmission or delivery.

In an embodiment, the apparatus 1200 for sending or receiving an HARQ may include a circuit. The circuit may implement the functions of sending, receiving, or communicating in the aforementioned method embodiments. The processor and transceiver described in the present disclosure may be implemented in an integrated circuit (IC), an analog IC, a radio frequency integrated circuit (RFIC), a mixed signal IC, an application specific integrated circuit (ASIC), a printed circuit board (PCB), or an electronic device, etc. The processor and transceiver may also be manufactured by using various IC process technologies, such as the complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), or gallium arsenide (GaAs), etc.

The apparatus for sending or receiving an HARQ in the above description of the embodiments may be a network device or a terminal device, but the scope of the apparatus for sending or receiving an HARQ described in the present disclosure is not limited thereto. The structure of the apparatus for sending or receiving an HARQ may not be limited by FIG. 10-FIG. 11. The apparatus for sending or receiving an HARQ may be an independent device or may be part of a larger device. For example, the described apparatus for sending or receiving an HARQ may be:
(1) an independent integrated circuit (IC), a chip, or a chip system or subsystem;
(2) a set with one or more ICs, optionally, the IC set may also include a storage component used for storing data and computer programs;
(3) an ASIC, such as a modem;
(4) a module that is capable of being embedded in other devices;
(5) a receiving device, a terminal device, an intelligent terminal device, a cellular phone, a wireless device, a handheld device, a mobile unit, an in-vehicle device, a network device, a cloud device, or an artificial intelligence device, etc.;
(6) others and so on.

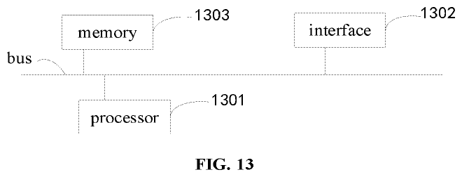

For the case where the apparatus for sending or receiving an HARQ may be a chip or a chip system, please refer to the schematic diagram of the structure of the chip shown in FIG. 13. The chip shown in FIG. 13 includes a processor 1301 and an interface 1302. In some embodiments, the number of processors 1301 may be one or more, and the number of interfaces 1302 may be more than one.

For the case where the chip is configured to implement the functions of the network device in the embodiments of the present disclosure, the interface 1302 is configured to receive a code instruction and transmit the code instruction to the processor; and the processor 1301 is configured to run the code instruction to perform the methods of FIG. 2 to FIG. 5.

For the case where the chip is configured to implement the functions of the terminal device in the embodiments of the present disclosure, the interface 1302 is configured to receive a code instruction and transmit the code instruction to the processor; and the processor 1301 is configured to run the code instruction to perform the methods of FIG. 6 to FIG. 9.

Optionally, the chip further includes a memory 1303, and the memory 1303 is configured to store necessary computer programs and data.

Those skilled in the art may also understand that various illustrative logical blocks and steps listed in the embodiments of the present disclosure may be implemented through electronic hardware, computer software, or a combination of the two. Whether such functions are implemented through hardware or software depends on the specific application and design requirements of the overall system. Those skilled in the art can use various methods to implement the functions for each specific application, but this implementation should not be understood as exceeding the scope of protection of the embodiments of the present disclosure.

An embodiment of the present disclosure also provides a communication system. The system includes the apparatus for sending an HARQ as the terminal device and the apparatus for receiving an HARQ as the network device in the embodiments of FIGS. 10-11; or the system includes the apparatus for sending an HARQ as the terminal device and the apparatus for receiving an HARQ as the network device in the embodiment of FIG. 12.

The present disclosure also provides a readable storage medium that stores an instruction. The instruction, when executed by a computer, implements the functions of any of the foregoing method embodiments.

The present disclosure also provides a computer program product. The computer program product, when executed by a computer, implements the functions of any of the foregoing method embodiments.

The above embodiments may be implemented in whole or in part by software, hardware, firmware, or any combination thereof. When implemented by using software, the above embodiments may be implemented in whole or in part in the form of a computer program product. The computer program product includes one or more computer programs. When the computer program is loaded and executed on a computer, processes or functions in accordance with the embodiments of the present disclosure are produced in whole or in part. The computer may be a general purpose computer, a specialized computer, a computer network, or other programmable devices. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fiber optic, digital subscriber line (DSL)) or wireless (e.g., infrared, wireless, microwave, etc.) manner to another web site, computer, server, or data center. The computer-readable storage medium may be any usable medium to which the computer has access, or a data storage device such as a server, or a data center, etc. containing one or more usable media integrated. The usable medium may be a magnetic medium (e.g., floppy disk, hard disk, tape), an optical medium (e.g., high-density digital video disc (DVD)), or a semiconductor medium (e.g., solid state disk (SSD)), etc.

Those ordinary skilled in the art can understand that the first, second, and other numerical numbers involved in the present disclosure are only differentiations for the convenience of description, and are not used to limit the scope of the embodiments of the present disclosure or indicate the sequential order.

The at least one in the present disclosure may also be described as one or more, and the plurality may be two, three, four, or more, without limitation in the present disclosure. In the embodiments of the present disclosure, for a kind of technical feature, the technical features in the kind of technical feature are distinguished by “first”, “second”, “third”, “A”, “B”, “C”, and “D”, etc. The technical features described by “first”, “second”, “third”, “A”, “B”, “C”, and “D”, etc. are in no order of sequence or size.

The corresponding relationships shown in the tables in the present disclosure may be configured or predefined. The values of information in the tables are only examples and may be configured to other values, which are not limited by the present disclosure. When the correspondence relationships between information and parameters are configured, it is not necessarily necessary to configure all the correspondence relationships shown in the tables. For example, in the table of the present disclosure, some corresponding relationships shown in certain rows may not be configured. For another example, appropriate deformation adjustments may be made based on the above tables, such as splitting, merging, etc. The names of the parameters shown in the titles of the above tables may also use other names that can be understood by the communication device, and the values or representations of the parameters may also be other values or representations that can be understood by the communication device. When the above tables are implemented, other data structures may also be used, such as arrays, queues, containers, stacks, linear tables, pointers, linked lists, trees, graphs, structures, classes, heaps, or hash tables, etc.

The term predefine in the present disclosure may be understood as the term of define, pre-define, store, pre-store, pre-negotiate, preconfigure, solidify, or pre-fire.

Those ordinary skilled in the art can realize that the units and algorithm steps of each example described in combination with the disclosed embodiments in this article can be implemented in electronic hardware, or a combination of computer software and electronic hardware. Whether these functions are executed in the form of hardware or software depends on the specific application and design constraints of the technical solution. Professional technicians may use different methods to implement the described functions for each specific application, but such implementation should not be considered beyond the scope of the present disclosure.

Those skilled in the art can clearly understand that for the convenience and conciseness of the description, the specific working processes of the systems, devices, and units described above may refer to the corresponding processes in the aforementioned method embodiments, and will not be repeated here.

It should be understood that steps may be reordered, added, or deleted by using various forms of processes shown above. For example, the steps documented in the embodiments of the present disclosure may be performed in parallel, sequentially or in a different order, as long as they can achieve the results desired by the technical solutions disclosed in the present application, which are not limited herein.

The above detailed description does not constitute a limitation to the scope of protection of the present invention. Those skilled in the art should understand that various modifications, combinations, sub-combinations, and substitutions may be made based on design requirements and other factors. Any modifications, equivalent substitutions, and improvements, etc. made within the spirit and principles of the present invention shall be included within the scope of protection of the present invention.

1. A method for sending a hybrid automatic repeat request (HARQ), comprising:
receiving, by a terminal device, downlink data;
generating, by the terminal device, HARQ feedback information based on the downlink data; and
sending, by the terminal device, based on a switching priority, the HARQ feedback information by using a first feedback mode or a second feedback mode, wherein the first feedback mode is delayed feedback on a current carrier, the second feedback mode is feedback on a candidate carrier, and the terminal device supports switching between the first feedback mode and the second feedback mode.

2. The method according to claim 1, further comprising:
receiving configuration signaling sent by a network device, wherein the configuration signaling is used for configuring the switching priority,
wherein the configuration signaling is radio resource control (RRC) signaling.

3. (canceled)

4. The method according to claim 2, wherein the sending, based on the switching priority, the HARQ feedback information by using the first feedback mode or the second feedback mode comprises:
sending, in response to a condition for the second feedback mode being satisfied, the HARQ feedback information by using the second feedback mode preferentially; and
sending, in response to the condition for the second feedback mode being not satisfied, the HARO feedback information by using the first feedback mode.

5. The method according to claim 2, wherein the sending, based on the switching priority, the HARQ feedback information by using the first feedback mode or the second feedback mode comprises:
sending, in response to determining that an available feedback resource is on the current carrier, the HARQ feedback information by using the first feedback mode preferentially; and
sending, in response to determining that no available feedback resource is on the current carrier, the HARQ feedback information by using the second feedback mode, wherein using the first feedback mode for feedback is further supported on the candidate carrier.

6. The method according to claim 2, wherein the sending, based on the switching priority, the HARQ feedback information by using the first feedback mode or the second feedback mode comprises:
sending, in response to determining that an available feedback resource is on the current carrier, the HARQ feedback information by using the first feedback mode preferentially; and
sending, in response to determining that no available feedback resource is on the current carrier, the HARO feedback information by using the second feedback mode, wherein using the first feedback mode for feedback is not further supported on the candidate carrier.

7. The method according to claim 1, further comprising:
receiving downlink control information (DCI) sent by a network device, wherein the DCI is used for indicating the switching priority.

8. The method according to claim 7, wherein the sending, based on the switching priority, the HARQ feedback information by using the first feedback mode or the second feedback mode comprises:
sending, in response to the DCI comprising a first identification, the HARQ feedback information by using the first feedback mode; and
sending, in response to the DCI comprising a second identification, the HARQ feedback information by using the second feedback mode.

9. The method according to claim 7, wherein the sending, based on the switching priority, the HARQ feedback information by using the first feedback mode or the second feedback mode comprises:
sending, in response to an uplink (UL) or a supplementary uplink (SUL) in the DCI being a first identification, the HARQ feedback information by using the first feedback mode; and
sending, in response to the UL or the SUL in the DCI being a second identification, the HARQ feedback information by using the second feedback mode.

10. The method according to claim 1, wherein the HARQ feedback information is sent by using the first feedback mode, and the method further comprises:
receiving a switching instruction; and
terminating the first feedback mode, and switching to the second feedback mode for sending the HARQ feedback information.

11. A method for receiving a hybrid automatic repeat request (HARQ), comprising:
sending, by a network device, downlink data to a terminal device; and
receiving, by the network device, HARQ feedback information sent by the terminal device, wherein the HARQ feedback information is generated by the terminal device based on the downlink data,
wherein the HARQ feedback information is sent, by the terminal device based on a switching priority, by using a first feedback mode or a second feedback mode, the first feedback mode is delayed feedback on a current carrier, the second feedback mode is feedback on a candidate carrier, and switching between the first feedback mode and the second feedback mode is supported by the terminal device.

12. The method according to claim 11, further comprising:
sending configuration signaling to the terminal device, wherein the configuration signaling is used for configuring the switching priority,
wherein the configuration signaling is radio resource control (RRC) signaling.

13. (canceled)

14. The method according to claim 12, wherein the switching priority is configured as:
preferentially using the second feedback mode for feedback in response to a condition for the second feedback mode being satisfied; and
using the first feedback mode for feedback in response to the condition for the second feedback mode being not satisfied.

15. The method according to claim 12, wherein the switching priority is configured as:
preferentially using the first feedback mode for feedback in response to a condition for the first feedback mode being satisfied; and
switching to, in response to the condition for the first feedback mode being not satisfied, the candidate carrier by using the second feedback mode, wherein using the first feedback mode for feedback is further supported on the candidate carrier.

16. The method according to claim 12, wherein the switching priority is configured as:
preferentially using the first feedback mode for feedback in response to a condition for the first feedback mode being satisfied; and
switching to, in response to the condition for the first feedback mode being not satisfied, the candidate carrier by using the second feedback mode, wherein using the first feedback mode for feedback is not further supported on the candidate carrier.

17. The method according to claim 11, further comprising:
sending downlink control information (DCI) to the terminal device, wherein the DCI is used for indicating the switching priority.

18. The method according to claim 17, wherein the switching priority is configured as:
sending, in response to the DCI comprising a first identification, the HARQ feedback information by using the first feedback mode; and
sending, in response to the DCI comprising a second identification, the HARQ feedback information by using the second feedback mode.

19. The method according to claim 17, wherein the switching priority is configured as:
sending, in response to an uplink (UL) or a supplementary uplink (SUL) in the DCI being a first identification, the HARQ feedback information by using the first feedback mode; and
sending, in response to the UL or the SUL in the DCI being a second identification, the HARQ feedback information by using the second feedback mode.

20. The method according to claim 11, wherein the HARQ feedback information is sent by the terminal device using the first feedback mode, the method further comprising:
sending a switching instruction, wherein the switching instruction is used for indicating the terminal device to terminate the first feedback mode and switch to the second feedback mode for sending the HARQ feedback information.

21-40. (canceled)

41. A communication device, comprising a processor and a memory, wherein the memory stores a computer program, and the processor, through executing the computer program, is configured to:
receive downlink data;
generate HARQ feedback information based on the downlink data; and
send, based on a switching priority, the HARO feedback information by using a first feedback mode or a second feedback mode, wherein the first feedback mode is delayed feedback on a current carrier, the second feedback mode is feedback on a candidate carrier, and the communication device supports switching between the first feedback mode and the second feedback mode.

42. A communication device, comprising a processor and a memory, wherein the memory stores a computer program, and the processor executes the computer program stored in the memory to cause the device to perform the method according to claim 11.

43-46. (canceled)
